(19) United States
(12) Patent Application Publication
(10) Pub. No.: US 2013/0111513 A1
(43) Pub. Date: May 2, 2013

(54) System and Method For Managing Distributed Content

(71) Applicant: Nicolas Gaude, Issy Les Moulineaux (FR)

(72) Inventor: Nicolas Gaude, Issy Les Moulineaux (FR)

(73) Assignee: Cisco Technology Inc., San Jose, CA (US)

(21) Appl. No.: 13/805,517

(22) PCT Filed: Jun. 21, 2011
(86) PCT No.: PCT/IB2011/052704

§ 371 Date: Jan. 7, 2013

(30) Foreign Application Priority Data
Jun. 29, 2010 (GB) 1010872.8

(51) Int. Cl. H04N 21/442

(52) U.S. Cl. CPC H04N 21/442
USPC 725/14

(57) ABSTRACT

A system and method for managing distributed content in a content distribution network. Related apparatus and methods are also described.

### FIELD OF THE INVENTION

The present invention relates to a system and method for managing distributed content, and in particular but not exclusively, to such a system and method for managing such content for a media distribution network.

### BACKGROUND OF THE INVENTION

Television broadcasters, for example through cable television networks, typically provide many if not most television shows at fixed times. Therefore if a viewer is not available to watch a particular show at that time, or the viewer wishes to view a different show at the same or overlapping times, then the viewer may choose to rely upon a “catch up” service offered by the television broadcaster. Such a “catch up” service typically does not rely upon the viewer deciding to record the content or otherwise take any action in advance of the time during which the show is provided; rather, it enables the viewer to decide to retrieve and view the show after it has already been provided.

References relevant to the subject of distribution of television content through a television content distribution network include published PCT Application No. WO 2008/012488 to Bachet et al; European Patent No. EP 1479236 B1 to Chiu; published US Application No. 2003/0237097 to Marshall; published PCT Application No. WO 2005/076616 to Kelly et al; and published US Application No. 2003/0126277 to Sung et al.

### SUMMARY OF THE INVENTION

The present invention, in certain embodiments thereof, seeks to provide an improved system and method for managing content distribution.

The present invention, in at least some embodiments seeks to provide a system and method for managing distributed content for a media distribution network having a plurality of media devices, in which portions of content are stored throughout the media distribution network and are accessed on a “peer to peer” basis by the media devices. Management of the content distribution, storage and “peer to peer” access is performed by one or more central servers in the media distribution network. Management of content distribution and storage by the one or more central servers includes at least determination of the content portions to be stored by the network storage peers, which may also optionally be the media devices or associated with the media devices (for example through co-location). Sufficient recording and storage coverage of the content is optionally guaranteed through one or more statistical models that govern the amount and timing of content recording and storage.

The acronyms used herein are defined in the following list:

AES—Advanced Encryption Standard;

AMS—Audience Measurement System;

APG—Advanced Program Guide which is an over-the-air encoding used for schedule information;

CA—Conditional Access;

CAS—Conditional Access System including components in the STB and the head-end that deal with conditional access (CA), for example, but not limited to, head-end components such as the EMMG (ACC) and ECMG (BCC);

CWP—Control Word Packet which is part of the conditional access system used by platforms based on the DSS transport;

DES—Data Encryption Standard; DHCP—Dynamic Host Configuration Protocol; DRM—Digital Rights Management;

DSL—Digital Subscriber Line which is a family of technologies that provide digital data transmission over the wires of a local telephone network;

DSM-CC—Digital Storage Media Command and Control; DSS—DIRECTV transport protocol; DVB—Digital Video Broadcasting standard;

DVR—Digital Video Recorder;

ECM—Entitlement Control Message which is part of the conditional access system used by platforms based on MPEG-2 transport streams;

EIT—Event Information Table; EPG—Electronic Program Guide;

ESS—Event Synchronization System;

FEC—Forward Error Correction;

GOP—Group of Pictures;

KWT—Keyword table; IP—Internet Protocol;

MFTP—Multicast File Transfer Protocol;

NAS—Network attached storage;

NSA—Native Scrambling Algorithm;

P2P—Peer To Peer; PAT—Program Association Table which is an MPEG-2 table used o describe all the services within a transport stream;

PC—Personal Computer;

PCR—Program Clock Reference which, as a non-limiting example, is a 42 bit clock sample running at 27 mega Hertz that is inserted in to an MPEG-2 transport stream to enable service components, such as video and audio, to be synchronized, in some systems the PCR being carried as a 33 bit clock sample using a 90 kilo Hertz clock, but the PCR can be converted to a 27 mega Hertz 42 bit value by multiplying by 300);

PID—Program Identifier which is an identifier that is assigned to each stream within an MPEG-2 transport stream;

PIN—Personal Identification Number;

PMT—Program Map Table which is an MPEG-2 table used to describe the PIDs assigned to a service;

PPV—Pay Per View;

PSI—Program Specific Information; PVR—Personal Video Recorder which is a storage enabled set-top box;

RASP—Random Access Scrambled Stream Protocol;

RECM—Reference ECM which is placed in a transport stream and including an identifier used to find another ECM which can be used to create a control word;

RSS—Really Simple Syndication;

RTS—Reference Time Stamp which is a 32 bit timecode, running at 27 mega Hertz, that is inserted in to a DSS stream to enable service components such as video and audio, to be synchronized; SAP—Session Announcement Protocol;

SCID—Service Channel Identification which is an identifier that is assigned to each stream within a DSS transport stream;

SDP—Session Description Protocol;

SI—Service Information;

SIG—SI Generator which is a head-end component that is used to generate data structures for transmission;

STB—Set-top Box;

SSR—Stream Server which is a digital TV control system designed to generate, process and manage DVB SI and PSI information & data streams to support pay and free-to-air TV; the SSR also manages and synchronizes the configuration of transmission & conditional access equipment;

SVP—Secure Video Processor;

URL—Uniform Resource Locator;

VOD—Video on demand;

XML—Extensible Markup Language; and

XSI—Extended SI which is an over-the-air encoding used for schedule information (extended SI may be required when more sophisticated features are necessary for being used in the EPG compared to regular information made available via SI).

The following terms used in the specification and claims are defined as follows: Content—any block or stream of audio and/or visual data available for retrieval and consumption by the subscriber, for example, but not limited to, a movie or other TV program, music, an application such as a game, or an interactive application such as a shopping application; and

Event or program—a television program, and/or radio program and the like.

### BRIEF DESCRIPTION OF THE DRAWINGS

The present invention will be understood and appreciated more fully from the following detailed description, taken in conjunction with the drawings in which:

FIG. 1 shows a simplified block diagram illustration of a system for managing distributed content, the system being constructed and operative in accordance with an exemplary embodiment of the present invention;

FIG. 2 shows a flowchart of an exemplary, illustrative method according to at least some embodiments of the present invention;

FIG. 3 shows a simplified partly pictorial, partly block diagram illustration of a system for managing distributed content, the system being constructed and operative in accordance with an exemplary embodiment of the present invention in which the content comprises television signals;

FIG. 4 shows a schematic block diagram of an exemplary system 400 according to at least some embodiments of the present invention; and

FIG. 5 shows a simplified partly pictorial, partly block diagram illustration of a system for managing distributed content, the system being constructed and operative in accordance with an exemplary embodiment of the present invention in which the content comprises television signals.

### DETAILED DESCRIPTION OF SOME EMBODIMENTS

The present invention, in at least some embodiments seeks to provide a system and method for distributed content for a media distribution network having a plurality of media devices, in which portions of content are stored throughout the media distribution network and are accessed on a “peer to peer” basis by the media devices, but are managed by one or more central servers in the media distribution network. Management of content distribution and storage by the one or more central servers may include at least determination of the content portions to be stored by the network storage peers, which may also optionally be the media devices or associated with the media devices (for example through co-location).

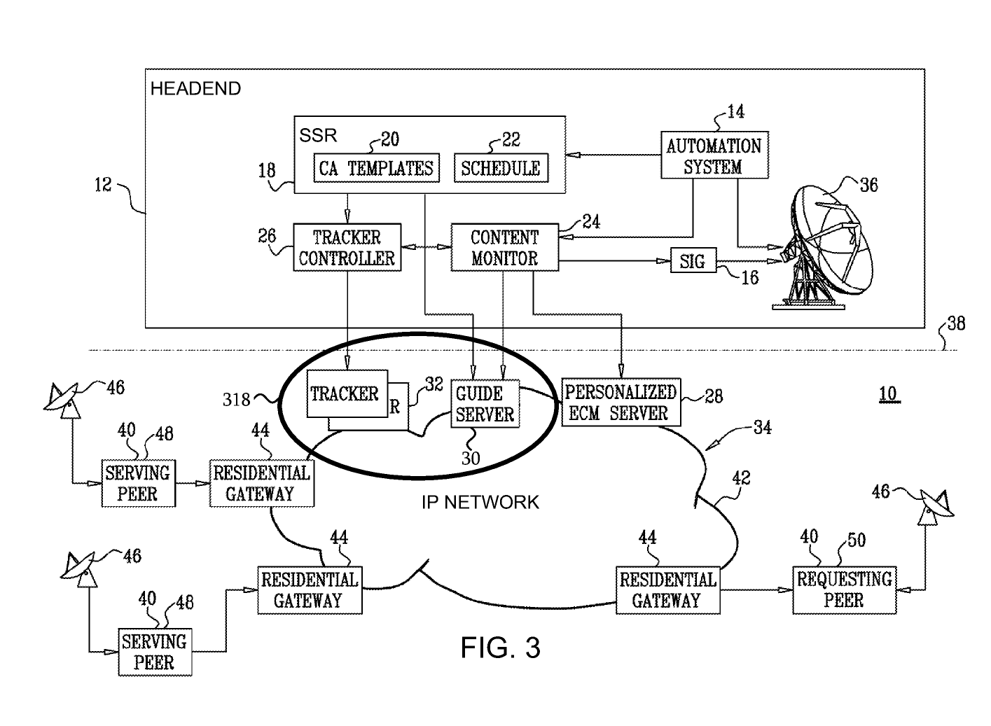

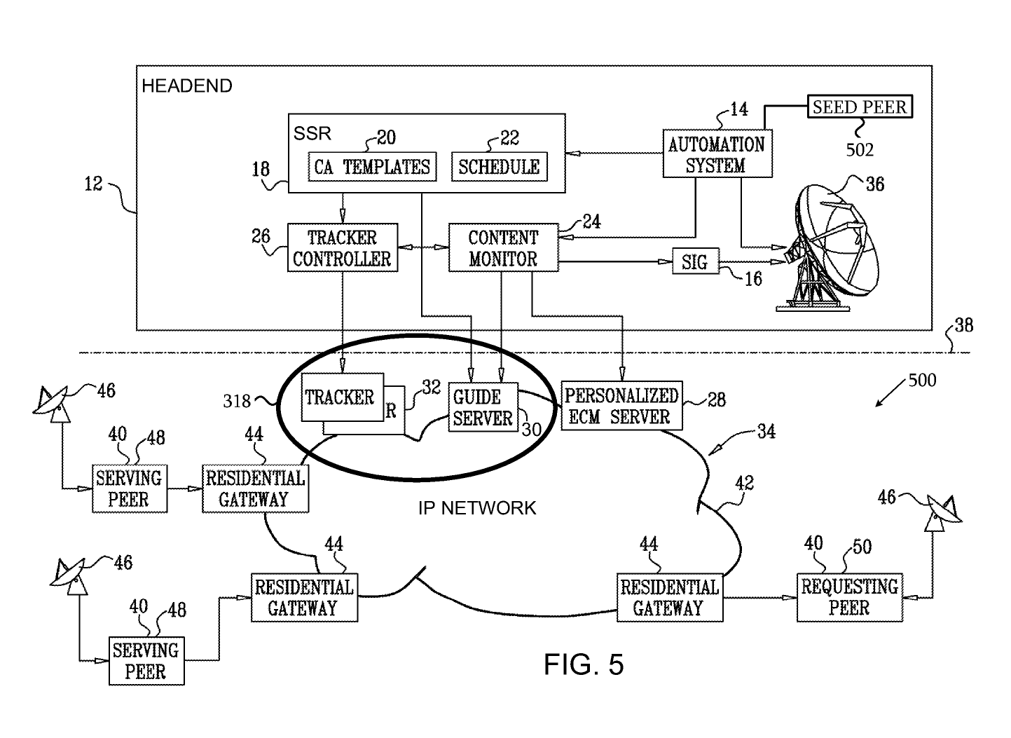

Various implementations of the content distribution network are encompassed within different embodiments of the present invention; a non-limiting example as provided herein relates to a television signal distribution network (as described with regard to FIGS. 3 and 5), although it is understood that optionally many different types of media distribution networks could optionally be implemented according to various embodiments of the present invention. Other non-limiting examples of media distribution networks according to different embodiments of the present invention include any type of audio distribution networks, any type of video distribution networks, gaming distribution networks, text (for example e-book) distribution networks and so forth. Also the television signal receiver is not necessarily part of a system of the below type; such non-limiting embodiments that feature such a television signal receiver are described with regard to FIGS. 3 and 5 but the implementation is not limited to the systems described in these Figures. The description below is intended as a non-limiting example only.

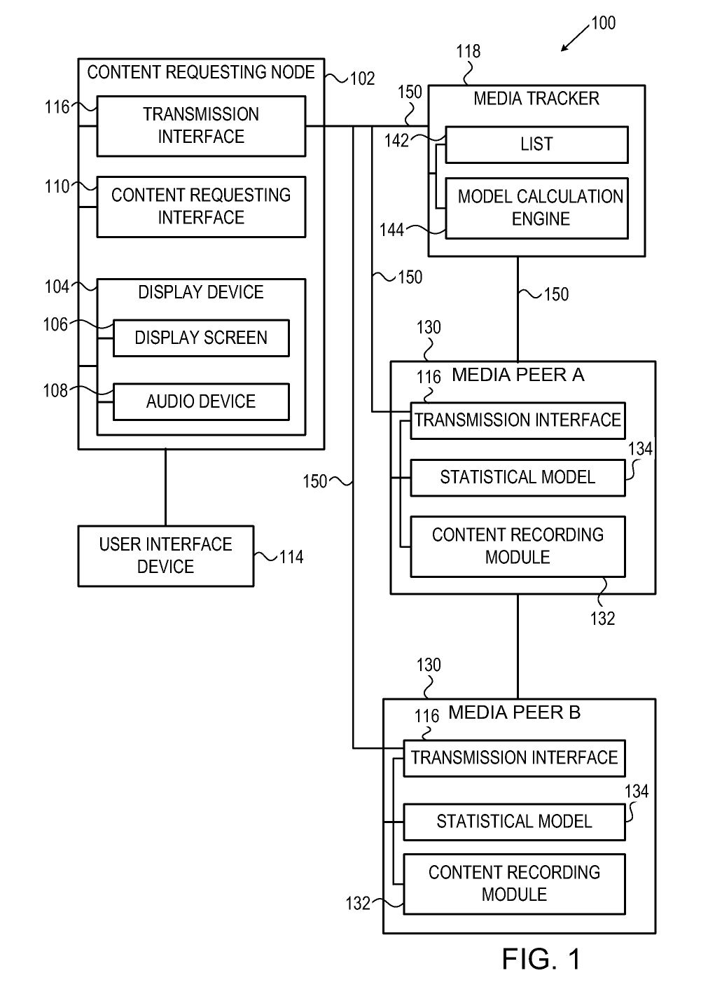

Reference is now made to FIG. 1 which is a simplified block diagram illustration of a system for managing distributed content, the system being constructed and operative in accordance with an exemplary embodiment of the present invention.

As shown, a system 100 features a content requesting node 102 for retrieving and playing back media of any type. Content requesting node 102 includes a display device 104; for this non-limiting example, display device 104 optionally features a display screen 106 and also optionally includes an audio playback device 108. However, optionally only audio playback device 108 or only display screen 106 is provided.

Content requesting node 102 also optionally is in communication with a user interface device 114 for issuing commands to content requesting node 102, which may optionally be in wired or wireless communication.

Content requesting node 102 is optionally in communication with a media tracker 118 for transmitting content through a media distribution network 150. Media distribution network 150 may optionally be any type of such a network; an optional non-limiting example of the network with regard to transmission of television signals is described with regard to FIG. 3. As shown, optionally content requesting node 102 communicates with media tracker 118 through a transmission interface 116. In system 100, media tracker 118 determines the location of content that is requested by content requesting node 102. Content requesting node 102 sends a request for particular content, by using a content requesting interface 110, to media tracker 118 through media distribution network 150. For example, if the content is provided through media distribution network 150 according to “channels” and time slots within such channels, then content requesting interface 110 optionally determines the correct channel and time slot for requesting the desired content. Alternatively or additionally, content requesting interface 110 may optionally act as a search engine interface, to allow the user to browse through available content within media distribution network 150, to search by keyword, theme, topic, and/or category, and so forth. Content requesting interface 110 may also optionally, additionally or alternatively, feature an EPG (electronic program guide) as is known in the art, which may optionally be used to determine the availability of various types of content.

Once a request for a particular content unit has been made, media tracker 118 then optionally consults a list 142 to determine the location of the content at a media peer 130. Optionally, media peer 130 may also be a content requesting node 102 and vice versa, and each such unit may optionally feature all of the components of the other unit, but these two units are shown separately and with different reference numbers for the sake of convenience only and without wishing to be limited in any way. The location and identifier for media peer 130 is then provided to content requesting node 102 so that they can communicate directly in a peer to peer manner; as shown media peer 130 and content requesting node 102 optionally communicate through media distribution network 150 as well, also through transmission interfaces 116 as shown.

Typically, the requested unit of content is present in a plurality of separate portions at a plurality of different media peers 130 (shown as “A” and “B”) and so media tracker 118 then provides a list of separate locations and identifiers for a plurality of separate media peers 130 to content requesting node 102, which may optionally also include the sequence of the content portions. For example, media tracker 118 may optionally instruct content requesting node 102 to assembly the plurality of portions from media peers 130 by starting with a portion from media peer 130 “A”, then adding a portion from “B” and so forth (optionally including another portion from the same media peer 130 at a later point in the sequence). Alternatively, the sequence of the content portions may optionally be included with each such portion as received from each media peer 130 by content requesting node 102, so that content requesting node 102 is able to assemble the portions from different media peers 130 in the correct order.

It is also possible that the content portions (or “chunks”) may optionally overlap, in which case content requesting node 102 receives instructions from media peers 130 and/or from media tracker 118 regarding the location and duration of the overlap, so that the portions may be seamlessly assembled for playback through display device 104.

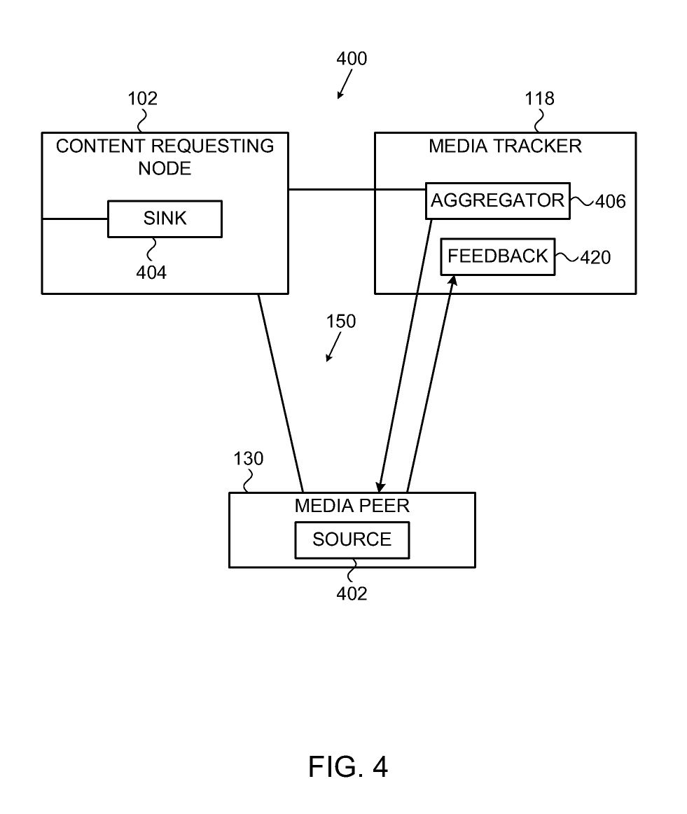

Some exemplary, non-limiting illustrative methods and system for determining the boundaries between portions (or “chunks”) and reassembling such portions are described with regard to FIGS. 3 and 4 below.

According to some embodiments of the present invention, the different content portions are provided to each media peer 130 through media distribution network 150 as a by-product of the typical distribution of content. In these embodiments, content is typically distributed through media distribution network 150 through one or more predetermined channels and at predetermined time slots. Therefore, media peer 130 records one or more portions of one or more units of content during the typical distribution pattern. Recording is optionally performed by a content recording module 132, which may optionally be implemented according to any suitable type of DVR (digital video recorder) for video streams or any suitable type of recording device as is known in the art that is suitable for the content being recorded. Optionally, content recording module 132 also stores the recorded content, although content may also be stored at a separate device or even a separate location from media peer 130 (not shown).

The determination of when and what to record is optionally made by media peer 130 according to guidance from media tracker 118. Such guidance also determines whether a unit of content is to be recorded and stored more than once throughout media distribution network 150 (typically each unit of content is recorded and stored at a plurality of media peers 130; if divided into a plurality of portions, then each complete set of portions is optionally stored more than once over the plurality of media peers). The guidance may optionally feature directions from media tracker 118 to media peers 130, but typically is provided to media peers 130 for local retention as one or more guidelines, or optionally as a statistical model 134 as shown. Statistical model 134 provides statistical guidelines with regard to when to record, how much to record, how often to record, what to record and so forth. If such general guidance is provided, such as statistical model 134 for example, then each media peer 130 reports which portion of each unit of content was recorded to media tracker 118, so that media tracker 118 can prepare list 142.

To assist in the preparation of the guidance, such as the construction of statistical model 134, a model calculation engine 144 at media tracker 118 determines which guidance is to be provided to each media peer 130. For particularly popular content units, for content units which are anticipated to be particularly popular, and/or according to feedback from requests by content requesting nodes 102, model calculation engine 144 may optionally adjust such guidance, for example by adjusting statistical model 134 to increase the overall statistical frequency of recording of particular units of content. Model calculation engine 144 may also optionally adjust such guidance to reduce bandwidth consumption throughout media distribution network 150 or within a particular portion (for example, if a particular unit of content or content type is particularly popular within a particular geographical region, corresponding to a particular portion of media distribution network 150).

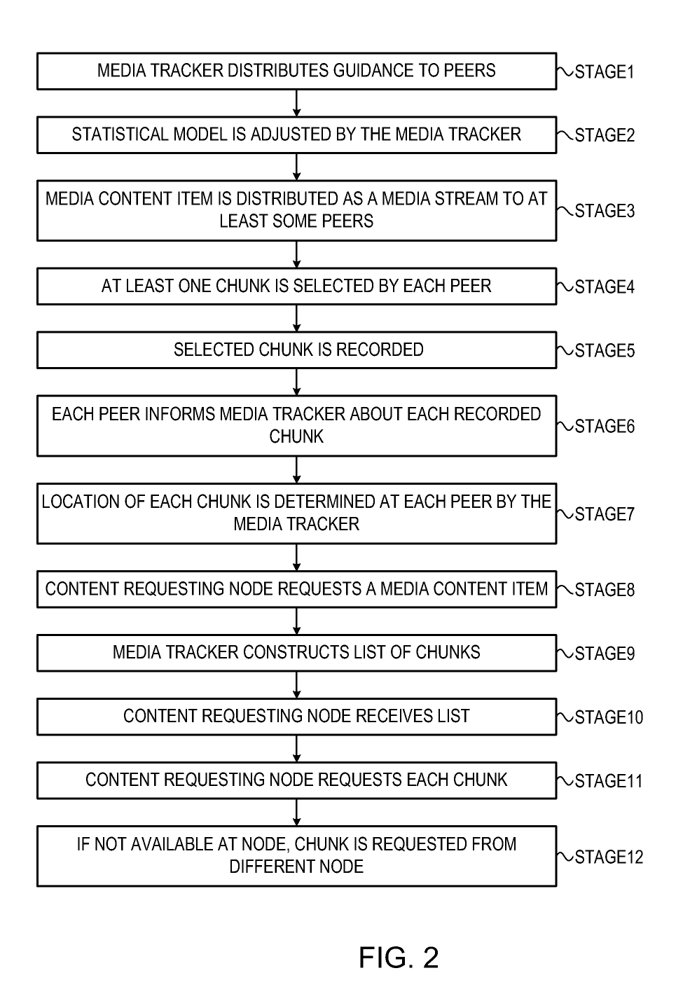

FIG. 2 shows a flowchart of an exemplary, illustrative method for the operation of the system of FIG. 1, for distributing media content items as a plurality of chunks (or portions) through a media distribution network to a plurality of peers; one or more content requesting nodes may then request the content from the peers. As described herein, optionally the content requesting node or nodes and the peers may swap functionality, so that content requesting nodes may also optionally act as receiving peers and vice versa.

As shown in stage 1, the media tracker distributes guidance to the plurality of peers for selecting and recording chunks of the media stream. The guidance may optionally comprise a statistical model. The statistical model optionally comprises a uniform law algorithm and is also optionally determined according to a number of peers available for recording and a total amount of media content items to be recorded throughout the network. The guidance also optionally includes a uniform length of each chunk to be recorded.

In stage 2, optionally the statistical model is adjusted by the media tracker according to a popularity of said media content item, the amount of bandwidth traffic or a combination thereof.

In stage 3, a media content item is distributed as a media stream to at least some, but not necessarily all, of the plurality of peers. Although each content item may be decomposed to a plurality of chunks for distribution by the network, in this example, it is distributed by the media distribution network as a stream.

In stage 4, at least one chunk is selected by each of said plurality of peers from said media stream to form a selected chunk, such that each peer decomposes the stream to a plurality of chunks and then selects at least one chunk. However, each peer does not necessarily decompose the entire stream to chunks, but may instead select a particular chunk from the stream and hence only decompose the selected chunk or chunks. The chunk is optionally selected randomly by each peer, and/or according to the previously described guidance.

In stage 5, the selected chunk of the media content item from the media stream is recorded by each of said plurality of peers to form a recorded chunk.

In stage 6, each peer informs the media tracker of an identifier for each recorded chunk, the identifier comprising identification of the recorded chunk and of the peer.

In stage 7, the location of each chunk of the media content item is determined at each peer by the media tracker, optionally to prepare the above described list.

In stage 8, the content requesting node requests a media content item from the media tracker.

In stage 9, the media tracker constructs the list of locations and identifiers of all necessary chunks to reassemble the media content item by selecting a plurality of peers having these chunks at least partially according to a distance from said content requesting node in the network. The distance is optionally at least partially determined according to an amount of available bandwidth between each peer and the content requesting node.

In stage 10, the content requesting node receives the list of a plurality of peers having recorded chunks of the media content item from the media tracker, including their locations and identifiers of the chunks.

In stage 11, the content requesting node requests each recorded chunk from each peer on the list.

In stage 12, if a recorded chunk is not available from a peer, the content requesting node requests the recorded chunk from another peer on the list.

FIG. 3 shows a simplified partly pictorial, partly block diagram illustration of a system for managing distributed content, the system being constructed and operative in accordance with an exemplary embodiment of the present invention in which the content comprises television signals. Of course the present invention is not limited to such an implementation and/or to such content and many other implementations and/or types of content are possible.

The television signals may optionally include a satellite, broadcasting, a cable network, through any suitable type of unicast or multicast technology, over a computer network or from a cellular telephone network (not shown). The term “broadcaster” optionally refers to an entity transmitting content over the transmission network, or the transmission network itself or a part thereof. By “television signal” it is meant various types of transmitted material, such as television programs, commercials, video clips, program guides and electronic program guides (EPGs), data, multimedia information, hypermedia links, computer programs, computer data and applications which may be downloaded, program applets and teletex.

A system 10 optionally includes a broadcasting Headend 12 including a plurality of Headend components and a plurality of peer-to-peer components. The Headend components optionally include an automation system 14, an SIG 16, a transmitter 36 and an SSR 18 including CA templates 20 and a schedule 22. The transmitter 36 is optionally operative to broadcast content, for example, but not limited to, via satellite, cable, or terrestrial broadcast. The peer-to-peer components optionally include a content monitor 24 and a tracker controller 26. The peer-to-peer system 10 also optionally includes other peer-to-peer components typically disposed in an access network 34 which is external to the Headend 12. The other peer-to-peer components may typically include a personalized ECM server 28 but also includes a media tracker 318, shown as a guide server 30 and a plurality of trackers 32.

The content monitor 24 is optionally operationally connected to the tracker controller 26, the automation system 14 (through which the content may be provided), the SIG 16, media tracker 318 and the personalized ECM server 28. The tracker controller 26 is optionally operationally connected to the trackers 32 and the SSR 18.

The broadcasting Headend 12 is optionally separated from the access network 34 by a firewall 38. The peer-to-peer system 10 also includes a plurality of peers 40, optionally located in the homes of subscribers to the peer-to-peer system 10. The peers 40 are typically PVRs or STBs associated with storage devices for example, a disk of a PC in a home network. Each peer 40 is optionally operationally connected via a residential gateway 44 to a communications network, including but not limited to an IP network 42, Asynchronous Transfer Mode (ATM) or Internetwork Packet Exchange (IPX) (the latter two are not shown).

Each of the peers 40 typically has a broadcast receiver 46 to receive content items (not shown) broadcast from the transmitter 36 of the broadcasting Headend 12. The content items may be recorded by the peers 40 and stored in an associated storage arrangement, such as a hard disk of the peers 40 or an NAS device. The content items may then be shared between the peers 40 via the IP network 42. It will be appreciated by those ordinarily skilled in the art that one or more of the peers 40 may not have the broadcast receiver 46 and only receive content from other peers 40.

A peer 40 which has content stored therein available for upload to another peer 40 is termed a serving peer 48. A peer 40 which requests content from another peer 40 is termed a content requesting node 50 (only one shown for the sake of clarity). The content requesting node 50 typically makes requests to multiple serving peers 48 in order to acquire the content quicker than a transfer from a single serving peer 48.

It will be appreciated that a peer 40 may be a serving peer 48 or a content requesting node 50 and frequently both at the same time, as previously described.

One serving peer 48 may upload to multiple content requesting nodes 50 at the same time and may also act as a content requesting node 50 for another piece of content or other sections of the same piece of content. The sharable content stored in the serving peer 48 was generally acquired from a broadcast tuner (broadcast receiver 46) of the serving peer 48 or an IPTV stream or from another one of the peers 40 in the peer-to-peer system 10. The term “download”, as used in the specification and claims, is defined as the process of receiving data. The term “upload”, as used in the specification and claims, is defined as the process of sending data. For example, when the content requesting node 50 downloads data from one of the serving peers 48, then the serving peer 48 uses the upload capacity of the broadband connection of the serving peer 48 to deliver data to the content requesting node 50.

So when the content requesting node 50 downloads a content item from the serving peers 48, the content requesting node 50 optionally takes benefit of the download speed to request different sections of the content items from a plurality of different serving peer 48 due to the limitation of the upload capacity of each of the serving peers 48.

Therefore, each sharable content item is optionally divided into sections called chunks and sub-chunks. The serving peers 48 record the selected chunks as previously described and the report the identity of the recorded chunks to media tracker 318.

As previously described, media tracker 318, amongst other functions, typically includes a list of sharable content as well as metadata used for sharing and playing the content, known as chunk metadata and playback metadata, respectively. The media tracker 318 may also optionally implement sharing rules thereby controlling what content can be shared, when the content can be shared and who can share the content. The list of which serving peers 48 have which chunks of content may optionally be maintained at trackers 32.

The personalized ECM server 28, amongst other functions, typically provides the ECMs/CWPs for decrypting the content item.

It will be appreciated by those ordinarily skilled in the art that the personalized ECM server 28, guide server 30 and trackers 32 may also be disposed inside the Headend 12 as long as the peers 40 have access to the personalized ECM server 28 and media tracker 318.

The peer-to-peer system 10 is described herein with reference to MPEG-2 transport streams. However, it will be appreciated by those ordinarily skilled in the art that the system of the present invention, in certain embodiments thereof, may be implemented with any suitable transport stream, for example, but not limited to MPEG-2 program streams, DSS transport streams, ASF, and MPEG-4 file format.

The peer-to-peer system 10 is described herein with reference to sharing audio-visual content items. However, it will be appreciated by those ordinarily skilled in the art that the system of the present invention, in certain embodiments thereof, may be implemented to share any suitable binary format content, for example, but not limited to, interactive applications and personal content.

FIG. 3 describes a non-IPTV implementation of system 10; an IPTV implementation is also possible, which is optionally substantially the same as the non-IPTV implementation, except for the following differences. The content monitor 24 is typically replaced by a content monitor and scrambler (not shown). The automation system 14 generally feeds the content to the content monitor 24 which in addition to the other functions, encrypts and encodes the content. The SIG 16 and the transmitter 36 are replaced by a VOD server (not shown) which is connected to the IP network (not shown).

FIG. 4 shows a schematic block diagram of a non-limiting exemplary system for hashing content items into a plurality of chunks or portions, and then reassembling them.

As shown in FIG. 4, a system 400 again features a content requesting node 102, media peer 130 and media tracker 118, communicating through content distribution network 150, as for FIG. 1, to which reference is made with regard to the general functions of these components. Content requesting node 102 now features a sink 404; media peer 130 features a source 402, and media tracker 118 features an aggregator 406 and a feedback module 420. The operation is similar to that of FIG. 1 with the following additions.

Source 402 hashes all of the recorded chunks (for example optionally determining the boundaries of such chunks) and publishes the hashed-references to media tracker 118. Upon request from content requesting node 102, source 402 also transfer or manages the transfer of hashed chunks.

Aggregator 406 aggregates all hashes from sources 402 into virtual timelines, so as to be able to provide the list of media peers 130 that can provide each complete requested unit of content by providing all necessary chunks thereof.

Sink 404 requests from media tracker 118 the list of hashed-references and also receives the location of one or more available media peers 130 for a specific hashed-reference.

Media peer 130 also optionally provides feedback to feedback module 420 of media tracker 118, for example with regard to total amount of recorded chunks, time required for download, quality of listed chunks and so forth.

With regard to source 402, consider a hashed reference defined by the following structure (which may optionally be provided for a content item determined as a program or event within a stream, broadcast or otherwise distributed through a particular channel; the term “PCR” refers to “program clock reference” which is the location of a particular part of the distributed stream and may be used to determine boundary markers within the stream):

{

| | |
|---|---|
| ON_id, TS_id, S_id, | /* channel identification level */ |
| <hh:mm:ss:dd/mm/yyyy> | /* event identification level */ |

{

| | |
|---|---|
| previous_pcr_in_stream, | /* hashes identification level */ |

first_pcr in hash,
last_pcr in hash,
next_pcr_in_stream,
Bytes_Size,

}

}

After the recording process, source 402 parses the recorded bitstream to search PCR value boundaries, for example optionally by using a dichotomy-algorithm. The boundaries' granularity defines the atomic duration of each hash. For this non-limiting example, it is assumed that the time length of portions of the bitstream between the boundaries has an arbitrary fixed duration, which is not necessarily determined explicitly in advance. To illustrate this, for this example an arbitrary atomic duration of 540000 cycles of PCR values is allowed: e.g. 1 minute long for a 33 bit PCR frequency at 90 KHz, such that each hashed chunk of content starts with the packet transport that handles a PCR value that is the closest PCR value after a 540K PCR value boundary. For this non-limiting example, 540K is the chunk time length.

The hashed chunk of content ends at the appropriate boundary which is defined as the minimum PCR value that is larger than 540K and which is the end boundary of a packet (as it is not possible to set the boundary within a packet, since this would effectively divide the packet). It is possible, due to transmission or reception failure at the time of recording for example, that a chunk would include fewer packets than would otherwise be expected. To determine this value, consider a piece of recorded stream as shown in the below table:

| | packet id | | | | | | |
|---|---|---|---|---|---|---|---|
| | n − 2 | n − 1 | N | . . . | p | p + 1 | . . . |
| PCR | 1077977 | no | 1081000 | . . . | 1618950 | 1621953 | |
| value | | PCR | | | | | |
| PCR | −2003 | no | +1000 | . . . | −1050 | +1953 | |
| value | | PCR | | | | | |
| mod | | | | | | | |
| 540K | | | | | | | |

Source 402 builds a hashed-reference that corresponds to the content featured in packets from the “n” packet to the “p” packet, inclusive (described below as hashed-reference “green” for the purposes of description only). The structure of the example hashed-reference may optionally appear as follows:

{

Distributor ID
10:35:00/02/07/2007
{

previous_pcr_in_stream = 1077977
first_pcr in hash = 1081000
last_pcr in hash = 1618950
next_pcr_in_stream = 1621953
Bytes_Size = (n-p)*(packet_size)

}

}

Then source 402 sends this hashed-reference to media tracker 118 and waits for requests for its hashed pieces of content. The above process is useful, for example and without limitation, for handling transmission and/or reception failure at the time of recording the chunk, which may cause a packet to be lost. If media tracker 118 determines that the same chunk has been recorded more than once, then media tracker 118 optionally lists and supplies the details of a chunk having the most packets.

The main role of aggregator 406 is to maintain the list of available sources for each channel timeline. The structure of a channel timeline is a composite structure of the hashed-references and all source identifiers. The location of source 402 may optionally be retrieved from a source identifier as supplied by media tracker 118. Continuing the previous example, source 402 or sources 402 (not shown in FIG. 4 but given below as “source A” and “source B” for the purpose of description only and without intending to be limiting in any way) publish to media tracker 118 the hashed reference for the particular distributor record on Day 1.

The channel timeline structure on the morning of Day 1 could appear as shown in the below table:

| ~time | 10:05 | . . . | 10:30 | . . . | 10:35 | . . . | 11:00 | . . . | 11:30 |
|---|---|---|---|---|---|---|---|---|---|
| hashed | | | | | green | | | | |
| ref | | | | | | | | | |
| source | A | A | A & B | A&B | A &B | A&B | B | B | B |
| list | | | | | | | | | |
| max | | | | | (n-p) | | | | |
| size in | | | | | | | | | |
| packet | | | | | | | | | |

Each time a source 402 connects to media tracker 118, the source list is optionally updated according to hashed references published by the newly connected media peer 130.

When content requesting node 102 sends an EPG request, aggregator 406 retrieves from its channel timeline the list of hashed references that compose the request and the list of sources 402 (i.e. media peers 130) that possess each hashed reference.

Content requesting node 102 connects to the aggregator 406 at media tracker 118, retrieves the list of hashed references and all the source identifiers of media peers 130 that may possess the hashed references.

For example, on Day 17 content requesting node 102 is instructed to download the news that were broadcast on Day 1 from 10:30 to 11:30. Media tracker 118 sends content requesting node 102 the list of 60 hashed references and available sources 402 (A and B in this non-limiting example):

| | | | “10:35” | | | | |
|---|---|---|---|---|---|---|---|
| hashed ref | “10:30” | . . . | green | . . . | “11:00” | . . . | “11:30” |
| source list | A&B | A&B | A&B | A&B | B | B | B |
| size packet | | | (n-p) | | | | |

Content requesting node 102 in this example starts the process of downloading with the content indicated by the “green” hashed reference from the A or B sources 402, which as stated above, may optionally represent the “best” or most complete chunk as determined by media tracker 118. Then the (n-p)*(packet size) data buffer is copied to an output file at the position given by: (Ref(“10:30”).size_packet+ . . . +Ref(“10:34”).size_packet)*(packet size).

To ensure seamless concatenation, optionally only chunks of content which hashed references matching the following rules are permitted:

Given 3 successive hashed references (e.g. same channel identification, same day, successive in time) as follows: hashed_ref_previous, hashed_ref_current, hashed_ref_next, then to be accepted by the system, hashed_current fulfills the following rules:

hashed_ref_current. first_pcr in hash=hashed_ref_previous. next_pcr_in_stream

hashed_ref_current. last_pcr in hash=hashed_ref_next. previous_pcr_in_stream

To promote quality of the chunks, the best quality pieces of content are optionally promoted as previously described (for example regarding packet losses during transmission/reception at the time of recording, as described above). The aggregator 406 optionally sorts the source list of chunks from the largest size of hashed chunks to the chunks having the smallest size. Because the bitstream transmission error during broadcasting is mainly expressed by packet losses, one can make the assumption that the largest size of hashed chunks corresponds to the less corrupted bitstream. Optionally however the best boundaries are also considered (by comparing the expected boundary to the received boundary). The sorting of source list thereby promotes the best chunks.

As previously described, a statistical model is optionally used to determine when each media peer is to record. A non-limiting example of such a model for use with regard to regarding television program content (such as that described with regard to FIG. 3 above) is provided herein for illustrative purposes only. Such recording is optionally performed silently (when possible, not at a time that the regular user of the media peer requests recording of content).

On average these silent recordings occur R hours per day and target content randomly over the broadcast content of programs.

For this non-limiting example assume that the operator (entity controlling the content distribution network) wants to enable a catch-up service for N full-time channels for a depth of D days.

The probability for a single media peer to have recorded a specific program is given by:

$$P ( 1 , N , R ) = \frac{R}{24 \cdot N}$$

Considering that the probability for not recording with M media peers is the M-power of the probability of not recording with one media peer (Moivre formula for compound probabilities), then, it is determined that the probability for M media peers to have recorded a specific program is given by:

$$P ( M , N , R ) = 1 - {( 1 - \frac{R}{24 \cdot N} )}^{M}$$

Finally to estimate the probability of having at least T times recorded a specific program with M media peers the following equation may be used:

P(T,M,N,R)=P(T×M,N,R)

The number of times that a record (i.e. a particular chunk) is available in a virtual peer to peer network may be considered to be optimum when it compensates for the asymmetric factor of the requirement of a network connection for the media peer, which for example may require a connection to the Internet through ADSL as previously described. Commonly with such transmission systems, this factor has been empirically observed by the inventor to be around T=8; e.g. uploading bandwidth is 8 times smaller than the downloading bandwidth on such systems.

For a reasonable use-case (non-limiting example), the dilemma is to find the number of media peers that may be deployed to guarantee with 95% probability that all of the content of for example four full-time channels (in this non-limiting example; other numbers are also possible) will be available within a week with a duplication rate of 8 in the peer to peer infrastructure. To support this feature, in this example the operator may agree to dedicate 50 GB of media peer storage space to such recorded chunks. The bit-rate is considered to be about 4 MB/s. The above factors support the following calculation:

$$R = \frac{{50.10}^{9}}{{4.10}^{6}} \cdot \frac{8}{7 \times 3600} \approx 4 hours$$

### P=0.95

### T=8

### N=4

From the above, the following may be obtained:

$$M = 8 \cdot \frac{ln ( 20 )}{ln ( 24 / 33 )} \approx 563$$

For this non-limiting example, the critical mass of media peers deployed is ˜500 units to cover efficiently four channels of content with a one-week depth. Once the media peer units are deployed, the ignition time before the peer to peer infrastructure is sufficiently established to be useful is equal to the requested depth of recording e.g. one week in this non-limiting example.

As noted above, the recording process is optionally a silent recording, which occurs without conflict to recording by the user controlling the media peer (for example in its exemplary, optional implementation as a set top box or STB). Also as noted above, optionally coverage is optimized through a uniform law algorithm. This option is optimal when there is no conflict with the user's own recording and it is desired to achieve a uniform coverage of recording of the content transmitted during a specific period (such as a week for example), e.g. without favoring prime-time television signals compared to those signals distributed in the early morning.

One embodiment of the optimization algorithm includes a change to the uniform law for adapting to non-uniform coverage of recording during a specific period: for example to favor prime-time silent recording; and/or to handle the conflict issue with the user's recordings.

This change may optionally be made in an iterative manner, for example through analysis by the media tracker (optionally according to received feedback as previously described), such that the recording strategy roadmap is expected to converge to produce the expected coverage of the period.

To illustrate this, consider an example in which a recording television service for one specific channel is to be constructed, with a depth of one day (e.g. such that all content for the day is recorded). It is also known that on this day, 50% of the media peer users will record a sporting event lasting two hours (from 4 PM-6 PM) which is not broadcast on the channel covered by the recording service. It is assumed that the scheduling system seeks to maintain uniform recording coverage of period that copes with this special conflict (in this example, it is assumed that the user is free to record whatever content that is desired, without interference from this automatic recording process).

The initial uniform daily recording strategy is:

Timeslot

| | | 2:00- | 4:00- | 6:00- | |
|---|---|---|---|---|---|
| | . . . | 4:00 pm | 6:00 pm | 8:00 pm | . . . |
| Probability | Po | Po | Po | Po | Po |

To cope with the special conflict, the new optimized recording strategy would be:

Timeslot

| | | 2:00- | 4:00- | 6:00- | |
|---|---|---|---|---|---|
| | . . . | 4:00 pm | 6:00 pm | 8:00 pm | . . . |
| Probability | Po | Po | 2*Po | Po | Po |

This strategy provides a higher probability for an unoccupied media peer to record this specific time slot since it is known that half of the media peers will not be available for silent recording during this period, as these devices will be instead recording as directed by their regular users.

Another exemplary non-limiting embodiment of the coverage optimization is done with extension of the peer to peer infrastructure with “built-in” media peers that do not necessarily relate to, or are controlled by, a specific user, but instead are added to the transmission network to guarantee the coverage of specific television programs, as shown in FIG. 5, which is a simplified partly pictorial, partly block diagram illustration of a system for managing distributed content, the system being constructed and operative in accordance with an exemplary embodiment of the present invention in which the content comprises television signals. Components having the same or similar function as for system 10 of FIG. 3 have the same reference numbers.

As shown, a system 500 features all of the components of system 10 of FIG. 3, with an additional seed media peer server 502. Seed media peer server 502 may optionally receive pre-recorded content of these programs, for example as one or more complete programs, one or more portions of at least one program, each transmitted program or a combination thereof, and can therefore “seed” missing content for peer to peer distribution. Media tracker 318 receives the list of their one or more locations, identifiers and content chunks stored therein, for example from the operator or other entity controlling the transmission network (only one seed media peer server 502 is shown herein for the sake of clarity without intending to be limiting in any way). As shown, seed media peer server 502 receives content directly from headend 12, for example directly from automation system 14 as shown, optionally by being located at or contained within headend 12 as shown, or alternatively by being located separately from but directly connected to headed 12 (not shown).

It is appreciated that components of the present invention described herein as being implemented in software may, if desired, be implemented in ROM (read only memory) form. The components described herein as being implemented in software may, generally, be implemented in hardware, if desired, using conventional techniques.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination. It will also be appreciated by persons skilled in the art that the present invention is not limited by what has been particularly shown and described hereinabove. Rather the scope of the invention is defined only by the claims which follow.

1. A method for distributing media content items as a plurality of chunks through a media distribution network, the media distribution network comprising a plurality of peers, the method comprising:
providing a media tracker for determining the location of each chunk of each media content item, said media tracker comprising a statistical model calculation engine;
distributing a media content item as a media stream to a plurality of peers;
said statistical model calculation engine determining a statistical model for providing recording guidance to said plurality of peers;
said media tracker providing said statistical model to said plurality of peers;
for each peer of said plurality of peers:
said peer selecting at least one chunk from said media stream to form a selected chunk for said peer;
said peer recording said selected chunk of said media content item from said media stream to form a recorded chunk for said peer;
said peer informing said media tracker of an identifier for said recorded chunk, said identifier comprising identification of said recorded chunk and of said peer,
said peer selecting said at least one chunk being performed randomly by each peer of said plurality of peers according to said statistical model; and
determining a location of each chunk of said media content item at each peer by said media tracker.

2. (canceled)

3. (canceled)

4. The method according to claim 1, wherein said statistical model comprises a uniform law algorithm and is also determined according to a number of peers and a total amount of media content items to be recorded throughout the network.

5. (canceled)

6. The method according to claim 1, wherein said providing said statistical model further comprises adjusting said statistical model according to a-popularity of said media content item.

7. The method according to claim 1, further comprising providing a uniform length of each chunk to be recorded to each peer by said media tracker.

8. The method according to claim 1, further comprising providing uniform boundaries within a media content item of each chunk to be recorded to each peer by said media tracker.

9. The method according to claim 1, further comprising providing a content requesting node of the network to request a media content item;
retrieving a list of a plurality of peers having recorded chunks of said media content item by said content requesting node from said media tracker; and
requesting each recorded chunk from each peer on said list by said content requesting node.

10. The method according to claim 9, wherein if a recorded chunk is not available from a peer, requesting said recorded chunk from another peer on said list.

11. The method according to claim 9, wherein said retrieving said list of said plurality of peers comprises requesting said list by said content requesting node from said media tracker;
constructing said list by selecting a plurality of peers by said media tracker, wherein said plurality of peers is selected at least partially according to a distance from said content requesting node in the network; and
sending said list to said content requesting node.

12. The method according to claim 11, wherein said constructing said list further comprises determining said distance in the network at least partially according to an amount of available bandwidth between each peer and said content requesting node.

13. The method according to claim 9, wherein said content requesting node is also a peer in the network.

14. The method according to claim 13, wherein at least one peer is a seed peer server recording each content item, a plurality of content items or a specified portion or portions of at least one content item, or a combination thereof.

15. The method according to claim 1, wherein said media content item is a television program and said peer comprises a television receiver for receiving television signals.

16. The method according to claim 15, wherein said television receiver receives a television signal selected from the group consisting of a broadcast television signal, a unicast signal, a multicast signal, a signal transmitted over a cellular telephone network, a signal transmitted over a computer network, a signal transmitted by satellite and a signal transmitted by a cable television network.

17. The method according to claim 15, further comprising providing a television signal provider for providing said television signal, wherein said television signal provider controls said media tracker.

18. A system for distributing media content items as a plurality of chunks, the system comprising:
a media distribution network for distributing each media content item, said media distribution network comprising a media transmitter for transmitting each media content item as a media stream;
a plurality of peers communicating with said media transmitter and with at least one other peer through said media distribution network, wherein at least some of said plurality of peers each select and record at least a chunk of said media stream to form a recorded chunk for each peer;
a media tracker for determining the location of each recorded chunk of each media content item according to an identifier received from each of said at least some of said plurality of peers, said media tracker comprising a statistical model calculation engine; and
a content requesting node of the network for requesting a media content item by retrieving a list of a plurality of peers having recorded chunks of said media content item from said media tracker,
wherein said statistical model calculation engine determines a statistical model for providing recording guidance to said plurality of peers, and
said media tracker provides said statistical model to said plurality of peers, and
for each peer of said plurality of peers:
said peer selects at least one chunk from said media stream to form a selected chunk for said peer;
said peer records said selected chunk of said media content item from said media stream to form a recorded chunk for said peer;
said peer informs said media tracker of an identifier for said recorded chunk, said identifier comprising identification of said recorded chunk and of said peer, and
each said peer of said plurality of peers selects at least one chunk randomly according to said statistical model.

19. The system according to claim 18, wherein said content requesting node is also a peer in the network.

20. The system according to claim 19, wherein at least one peer in the network is a seed peer server recording each content item, a plurality of content items or a specified portion or portions of at least one content item, or a combination thereof.

21. The system according to claim 18, wherein said media content item is a television program and said peer comprises a television receiver for receiving television signals.

22. The system according to claim 21, wherein said television receiver receives a television signal selected from the group consisting of a broadcast television signal, a unicast signal, a multicast signal, a signal transmitted over a cellular telephone network, a signal transmitted over a computer network, a signal transmitted by satellite and a signal transmitted by a cable television network.

23. The system according to claim 21, further comprising a television signal provider for providing said television signal, wherein said television signal provider controls said media tracker.

24. The system according to claim 23, further comprising a seed peer server at the television signal provider.

25. (canceled)

26. (canceled)

27. The method according to claim 1, wherein said statistical model is designed to guarantee, with a chosen probability of success, that the plurality of peers will together record chosen content.

28. The system according to claim 18, wherein said statistical model is designed to guarantee, with a chosen probability of success, that the plurality of peers will together record chosen content.
